(19) United States
(12) Patent Application Publication
(10) Pub. No.: US 2023/0066481 A1
(43) Pub. Date: Mar. 2, 2023

(54) SYSTEM FOR PREPARING A DILUTED COMPOSITION

(71) Applicant: Bradley John CARPENTER, Narangba, Queensland (AU)

(72) Inventor: Bradley John Carpenter, Narangba, Queensland (AU)

(21) Appl. No.: 17/766,917

(22) PCT Filed: Oct. 8, 2020
(86) PCT No.: PCT/AU2020/051079

§ 371 Date: Apr. 6, 2022

(30) Foreign Application Priority Data
Oct. 9, 2019 (AU) 2019903797

(51) Int. Cl. B05B 7/04; G05D 11/13

(52) U.S. Cl. CPC B05B 7/0408; G05D 11/132

(57) ABSTRACT

Contrivances for dispensing or applying biologically active compositions such as insecticides and herbicides. More particularly, a system is provided that is capable of dispensing or applying a composition from a selection of available compositions and at a required concentration. In one version, the system includes first and second concentrate reservoirs, a diluent reservoir, and a diluent composition conduit. The system is configured such that a diluent in the diluent reservoir is mixed with a concentrate of the first or second concentrate reservoir to form a diluted composition. The diluted composition is prepared to a specified concentration by mixing the concentrate and diluent in appropriate proportions.

### FIELD OF THE INVENTION

The present invention relates generally to contrivances for dispensing or applying biologically active compositions such as insecticides and herbicides. More particularly, the invention provides a system that is capable of dispensing or applying one composition from a selection of available compositions and at a required concentration.

### BACKGROUND TO THE INVENTION

The use of insecticides, pesticides, paraciticides, herbicides, fungicides, antibiotics, fertilizers and other biologically active compositions is common place in many settings. For example, in agriculture and horticulture, herbicides may be sprayed onto crops, garden beds, walking paths and about structures to keep weeds at bay. In primary production, herd animals may be dosed with various medicinal compositions to kill parasites and other infectious agents.

In some applications the composition is applied directly from a tank onto the target. In other circumstances the composition is dispensed from a tank into a second vessel (such as a hand-held or body-mounted spray apparatus) before use.

Typically, a biologically active agent is supplied as a concentrated composition, with a worker being required to dilute the concentrate with water to form a composition having a desired concentration before use. As will be appreciated, the act of diluting the concentrate may pose a health risk to a worker where the active agent is potentially toxic or otherwise adverse to human health. For example, the ubiquitous herbicide Roundup™ (glyphosate) is a suspected carcinogen in circumstances where a worker habitually contacts the agent.

In many cases, the active agent in the composition must be present at a precise concentration, or within a prescribed concentration range. For example, a herbicide may only be effective at a minimum concentration, with the use of higher concentrations being wasteful or toxic to non-target species. Where the composition is a medicament (such as when drenching a farm animal) exceeding a maximum safe dosage may result in toxicity or death of the recipient. Preparation of a composition having a certain concentration of active agent can be time consuming, and on occasion may be performed incorrectly.

More accurate dilutions may be achieved where a higher volume of composition is prepared. As will be understood, dilution of 1 litre of concentrate into 9 litres of water will be more accurate than dilution of 10 ml of concentrate into 90 ml of water. However, preparation of larger volumes may be wasteful, and especially where the composition must be used immediately. Larger volumes are also more difficult to move about from one site to another.

A number scenarios require a worker to have a range of active compositions at hand. In one example, a local council worker may encounter a variety of noxious plant that requires a specific concentration of herbicide, or to apply a different herbicide to a previous target area. In some circumstances, a target area has multiple species of noxious plant each requiring the application of a different herbicide. The worker is typically forced to mix multiple compositions in the field, often directly in the tank which acts as the reservoir for the spray apparatus. This is very time inefficient and often leads to wastage as leftover solutions are dumped to allow a different composition to be loaded into the tank.

Such problems extend to other applications, such as farming. In surveying a property, a farmer may find cause to spray an insecticide to kill mosquitoes breeding in a pond and may then need to apply a herbicide to weeds growing about a building.

This need for multiple compositions causes problems in that the worker is forced to mix multiple compositions from a concentrate, and have the diluted compositions at hand when required. Where the compositions are dispensed from individual tanks and through a common pump and supply line, it is typically necessary to flush large volumes of the new composition to replace any remnants of the old composition. This leads to significant wastage of composition.

On many occasions a worker is required to dispense a biologically active composition at multiple locations. Accordingly, the dispensing apparatus may be mounted on a mobile apparatus such as a trolley, or a vehicle. Typically, a worker will prepare each composition at a base station, and carry each of the diluted compositions on the mobile apparatus from site to site. Where large volumes of each composition are required the mobile apparatus may have insufficient space to carry all of the required compositions.

It is an aspect of the present invention to provide an improvement to prior art means for dispensing a biologically active composition, optionally overcoming one or more problems of the prior art. It is a further aspect of the present invention to provide a useful alternative to prior art means for dispensing a biologically active composition.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system for dispensing a liquid composition, the system comprising: a first concentrate reservoir, a diluent reservoir, and a diluent composition conduit, wherein the system is configured such that a diluent in the diluent reservoir is contactable with a concentrate of the first concentrate reservoir to form a first diluted composition of a specified concentration.

In one embodiment of the first aspect, the system comprises a second concentrate reservoir, wherein the system is configured such that a diluent in the diluent reservoir is contactable alternately with (i) a concentrate of the first concentrate reservoir to form a first diluted composition of a specified concentration and (ii) a concentrate of the second concentrate reservoir to form a second diluted composition of specified concentration so as to form a second diluted composition.

In one embodiment of the first aspect, the first and/or second concentrate reservoirs is/are of lesser volume capacity than the diluent reservoir.

In one embodiment of the first aspect, the first and/or second concentrate reservoirs is/are of less than 50%, 40%, 30%, 20%, or 10% the volume capacity of the diluent reservoir.

In one embodiment of the first aspect, each of the first and second concentrate reservoirs has (i) a first and second concentrate outlet conduit respectively and (ii) first and second concentrate flow control means configured to control the flow of concentrate through the first and second concentrate outlet conduits respectively, wherein the system is configured such that concentrate flow through the first and second concentrate outlet conduits is independently controllable.

In one embodiment of the first aspect, the first and second concentrate flow control means are each a valve configured to adopt either an open or closed state.

In one embodiment of the first aspect, the system is configured such that a concentrate is prevented from passing between: the first and second concentrate reservoirs, and/or the diluent reservoir and the first concentrate reservoir and/or the diluent reservoir and the second concentrate reservoir.

In one embodiment of the first aspect, the system is configured such that a liquid is prevented from passing between the first and second concentrate reservoirs.

In one embodiment of the first aspect, the first and second concentrate outlet conduits are not in mutual liquid communication upstream of the first and second concentrate flow control means when the first and second concentrate flow control means are closed to prevent concentrate flow, but are in mutual liquid communication downstream of the first and concentrate control means are open to allow concentrate flow.

In one embodiment of the first aspect, the diluent reservoir has a diluent outlet conduit that is not in liquid communication with the first and second concentrate outlet conduits upstream of the first and second concentrate flow control means when the first and second concentrate flow control means are closed to prevent liquid flow, but is in liquid communication with the first and second concentrate outlet conduits downstream of the first and second concentrate flow control means.

In one embodiment of the first aspect, the first and second concentrate outlet conduits combine so as to form a common concentrate conduit, such combination occurring downstream of the first and second concentrate flow control means.

In one embodiment of the first aspect, the system comprises liquid flow rate control means configured to vary the flow rate of a liquid flowing through the first concentrate outlet conduit, the second concentrate outlet conduit, the diluent outlet conduit, or the common concentrate conduit (where present).

In one embodiment of the first aspect, the liquid flow rate control means is not an on/off valve.

In one embodiment of the first aspect, the liquid flow rate control means is configured to allow continuous variation of liquid flow rate, or step-wise variation of liquid flow rate.

In one embodiment of the first aspect, the liquid flow rate control means functions so as to vary the ratio of a diluent from the diluent reservoir to a concentrate from the first or second concentrate reservoir in the diluted composition outlet.

In one embodiment of the first aspect, the system is configured such that a diluent flowing through the diluent outlet conduit combines with a concentrate flowing through the first or second concentrate outlet conduit so as to form a diluted composition.

In one embodiment of the first aspect, the diluted composition conduit is in liquid communication with: (i) the diluent outlet conduit and (ii) the first concentrate outlet conduit, the second concentrate outlet conduit outlet, or the diluted composition conduit.

In one embodiment of the first aspect, the system comprises a conduit junction configured to provide liquid communication between (i) the diluent outlet conduit and (ii) the first concentrate outlet conduit, the second concentrate outlet conduit outlet, or the diluted composition conduit.

In one embodiment of the first aspect, the diluted composition conduit comprises an in line liquid mixer.

In one embodiment of the first aspect, the system comprises a liquid transport means configured to transport a diluted composition through the diluted composition conduit.

In one embodiment of the first aspect, the liquid transport means is a pump.

In one embodiment of the first aspect, the diluted composition conduit comprises an outlet and the pump is positioned so as to receive diluted composition and transport the diluted composition toward the outlet of the diluted composition conduit.

In one embodiment of the first aspect, the system comprises a conduit junction configured to provide liquid communication between (i) the diluent outlet conduit and (ii) the first concentrate outlet conduit, the second concentrate outlet conduit outlet, or the diluted composition conduit, wherein the pump is positioned downstream from the conduit junction.

In one embodiment of the first aspect, the pump is positioned downstream from the concentrate flow rate control means.

In one embodiment of the first aspect, the system comprises a liquid dispenser, wherein the diluted composition conduit feeds the liquid dispenser.

In one embodiment of the first aspect, the liquid dispenser is configured to output a jet or a spray or an aliquot of a diluted composition.

In one embodiment of the first aspect, the system comprises an elongate and flexible conduit disposed downstream from the diluted composition conduit and upstream from the liquid dispenser.

In a second aspect, the present invention provides a mobile platform having the system of any embodiment of the first aspect mounted thereon, therein, or thereabout.

In one embodiment of the second aspect, the mobile platform is a vehicle, a trailer, a trolley or a backpack.

In a third aspect, the present invention provides a method of applying a diluted composition to a target, the method comprising the steps of providing the system of any embodiment of the first aspect, disposing a concentrate into the first concentrate reservoir, disposing a diluent into the diluent reservoir, causing or allowing the diluent to contact the concentrate so as to form a diluted composition of a specified concentration, and causing or allowing the so-formed diluted composition to contact the target.

In a fourth aspect, the present invention provides a method of applying a diluted composition to a target, the method comprising the steps of providing the system of any embodiment of the first aspect, disposing a first concentrate into the first concentrate reservoir, disposing a second concentrate into the second concentrate reservoir, disposing a diluent into the diluent reservoir, causing or causing or allowing the diluent to contact either the first concentrate or the second concentrate so as to form either a first diluted composition of a specified concentration, or a second diluted composition of a specified concentration, and causing or allowing the so-formed first diluted composition or second diluted composition to contact the target.

In a fifth aspect, the present invention provides a method of applying a diluted composition to a target, the method comprising the steps of providing the system of any embodiment of the first aspect, disposing a first concentrate into the first concentrate reservoir, disposing a second concentrate into the second concentrate reservoir, disposing a diluent into the diluent reservoir, adjusting the liquid flow rate control means of the system, causing or allowing the diluent to contact the concentrate so as to form a diluted composition of a specified concentration, and causing or allowing the so-formed first diluted composition to contact the target.

In one embodiment of the third, fourth or fifth aspect, the concentrate is a concentrated composition is an agricultural or horticultural chemical. The agricultural or horticultural chemical is selected from the group consisting of a herbicide, a pesticide, an insecticide, a fungicide, a fertilizer, a soil conditioner, an antibiotic, a paraciticide, and a veterinary medicament.

### BRIEF DESCRIPTION OF THE FIGURE

FIG. 1 illustrates in highly diagrammatic form a system of the present invention.

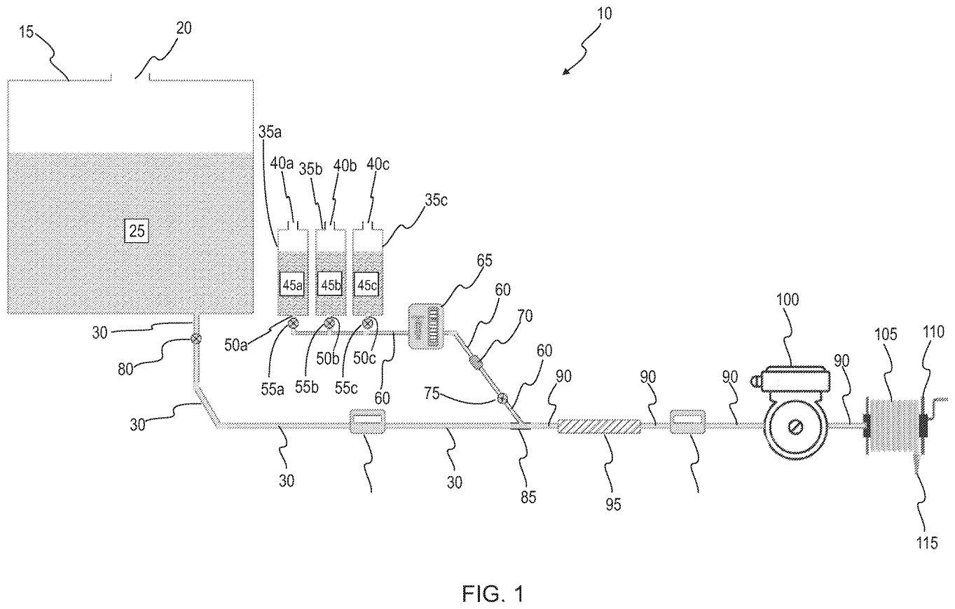

It will be understood that the drawing of FIG. 1 is not drawn to any scale and does not necessarily illustrate all features essential or desirable for operation. Moreover, the features illustrated in the drawing of FIG. 1 are not all necessarily essential or desirable for the operation of the invention.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The terms “upstream” and “downstream” are used in reference to the normal movement of a liquid from a reservoir to an outlet of the system, as would normally occur during operation when diluted composition is being applied to a target.

The present invention may be embodied in a system for dispensing a liquid composition, the system comprising: a first concentrate reservoir, a diluent reservoir, and a diluent composition conduit, wherein the system is configured such that a diluent in the diluent reservoir is contactable with a concentrate of the first concentrate reservoir to form a first diluted composition of a specified concentration. This embodiment of the invention is capable of delivering only a single type of diluted composition, however is capable of delivering that diluted composition at variable concentrations of active agent in the diluted composition. For example, this embodiment is capable of delivering a single herbicide at varying concentrations depending on the intended target weed.

In another embodiment of the invention, the system is capable of delivering multiple types of diluted composition, and at varying concentrations. In that regard the system of comprises a second concentrate reservoir, wherein the system is configured such that a diluent in the diluent reservoir is contactable alternately with (i) a concentrate of the first concentrate reservoir to form a first diluted composition of a specified concentration and (ii) a concentrate of the second concentrate reservoir to form a second diluted composition of specified concentration so as to form a second diluted composition. For example, this embodiment is capable of selectively delivering a single herbicide at varying concentrations depending on the target weed, and also selectively delivering a single insecticide at varying concentrations depending on the target insect species.

In one embodiment, the present invention provides a system by which a concentrate comprising an active agent may be diluted with a solvent to a specified concentration to provide a diluted composition for application to a target. Advantageously, preparation of the diluted composition does not require any measurement or handling by a worker.

Accordingly, occupational exposure to chemicals may be lessened, and diluted compositions prepared to a greater accuracy.

By the present invention, it is unnecessary for the worker to prepare any diluted composition in the field. All required concentrates may be loaded into the concentrate reservoirs (one concentrate per reservoir) in a controlled environment, such as a depot or a warehouse facility using appropriate measuring equipment. The worker (or indeed other personnel) is able to wear protective clothing, breathing apparatus, and gloves for particularly toxic concentrates. Once a concentrate is loaded into the system, it is not necessary for the worker to manipulate it in the field. Instead, as more fully described infra, the concentrate is accurately mixed with an appropriate amount of diluent so as achieve the desired final concentration of active agent.

The present invention for allows for the worker to select for a certain concentrate to be diluted and dispensed amongst two or more available concentrates according to the task at hand. For example, the system may be loaded with a herbicide concentrate, a fungicide concentrate and an insecticide concentrate. The system allows for the herbicide concentrate to be selectively mixed with diluent, to the exclusion of the fungicide and insecticides concentrates. Thus, the worker may firstly travel to a site requiring application of a herbicide to target (such as weeds) and upon selection by the worker of the herbicide concentrate for mixing with the diluent, the diluted composition is automatically prepared and dispensed via an output conduit and into a spray. The worker may travel to a second site to treat a fungus infestation of a tree, and which case selects the system to mix the fungicide composition with the diluent. At a third site it may be necessary to treat an ant nest with an insecticide, in which case the workers selects the insecticide concentrate for mixing with the diluent and dispensing.

In the present invention the diluent and concentrate are drawn from their respective reservoirs on as “as needed” basis and mixed to provide only the required amount of diluted composition for application to a target. By this approach, wastage of chemical is minimised given the avoidance of any need to discard any unused diluted composition.

The present invention will now be more fully described by reference (at least in part) to the accompanying non-limiting drawings. It is emphasised any modifications to the features of the drawn embodiment, or the presence or absence of any feature to or from the drawn embodiment may applied to the many embodiments of the invention which are not drawn.

Reference is made to the embodiment drawn as FIG. 1 which is directed to an embodiment allowing a worker to select from three different active agents (each in the form of a concentrate), and to deliver any of the three agents at a specified concentration after mixing with a diluent (typically water).

FIG. 1 shows generally a system (10) comprising a series of reservoirs. The largest reservoir is the diluent reservoir (15) having an inlet port (20) allowing for filling with a diluent (25). The diluent reservoir (15) further comprises an outlet conduit (30) configured to convey diluent (25) from the reservoir (15). Three smaller concentrate reservoirs (35a) (35b) (35c) are each provided with an inlet port (40a) (40b) and (40c) respectively, allowing for filling each reservoir (35a) (35b) (35c) with a different concentrate (45a) (45b) (45c) respectively. Each of the concentrate reservoirs (35a) (35b) (35c) further comprise an outlet conduit (50a) (50b) (50c) respectively configured to convey concentrate (45a) (45b) (45c) from its respective reservoir (35a) (35b) (35c).

The embodiment of FIG. 1, or any other embodiment described or claimed herein, may include one or more further diluent reservoirs where concentrates require different diluents. For example, many concentrates comprise agents which are water soluble, however some agents will be more readily soluble in an organic solvent or other non-aqueous liquid. In that case, the worker will be able to select for an appropriate solvent given the concentrate to be diluted and dispensed.

The embodiment of FIG. 1, or any other embodiment described or claimed herein, may comprise more or less than the three concentrate reservoirs drawn. It will be appreciated that in some embodiments only a single concentrate is required in the system, however different concentrations of that concentrate are required. In that circumstance, the single concentrate may be mixed in higher and lower amounts with the diluent to provide respectively higher and lower concentrations of agent in the diluted composition to be dispensed by the system. Two concentrates may be included where the worker requires no more than two different agents to be dispensed. In some embodiments, 4, 5, 6, 7, 8, 9 or 10 concentrate reservoirs are required where the system is required to dispense a larger number of agents.

One function of an embodiment of the present system (10) is to select a concentrate (45a) (45b) or (45c) from a number of concentrates (45a) (45b) (45c) for mixing with the diluent (25) at a required ratio so as to give a diluted composition having the active agent of the selected concentrate at a specified concentration. In the embodiment of FIG. 1, each concentrate (45a) (45b) or (45c) is loaded into its respective concentrate reservoir (35a) (35b) (35c) with each reservoirs respective filling port (35a) (35b) (35c). Each of the filling ports (35a) (35b) (35c) has a lid (not drawn) used to prevent the egress of concentrate if the system were to be upset. In the embodiment of FIG. 1 the selection concentrate is made by the actuation of valve (55a) (55b) or (55c), each of which is disposed in line to the first (50a), second (50b) and third (50c) concentrate outlet conduits respectively. Each of the valves (55a) (55b) (55c) may be considered first, second and third concentrate flow control means respectively.

To select concentrate (45a) the valve (55a) is opened and the valves (55b) (55c) are closed. To select concentrate (45b) the valve (55b) is opened and the valves (55a) (55c) are closed. To select concentrate (45c) the valve (55c) is opened and the valves (55a) (55b) are closed. In some circumstances the intention is to mix multiple concentrates with the diluent, and in which case the valve for each concentrate of the mix is opened, and the remainder closed.

In any event, downstream from the valves (55a) (55b) (55c) the first (50a) second (55b) and third (55c) concentrate outlet conduits join to form a common concentrate conduit (60). As will be appreciate, in the transition from a first concentrate to a second concentrate, remnants of the first concentrate will remain in the common concentrate conduit (60) and contaminate newly introduced second concentrate. Where such contamination is undesired, a short flushing or purging sequence may be used to expel a small volume of contaminated diluted composition from the system before actual application to a target.

The embodiment of FIG. 1, or any other embodiment described or claimed herein, the valves (55a) (55b) (55c) may be manually operable rotatory spindle type valves. In that case, the worker would take care to ensure that the relevant valve is completely opened or completely closed given that an intermediate flow through the valve may cause an error in the concentration of the active in the diluted composition produced by the system. In other cases, the valves (55a) (55b) (55c) may of the type which are switchable only between a completely open state and a completely closed state so as to avoid the possibility of undesired intermediate flow states being implemented. In some cases, the valves (55a) (55b) (55c) are solenoid valves which are manually operated by actuation of an electrical switch. Alternatively, a solenoid valve may be operated by some mechanical or electromechanical means, electrical means, or electronic means by way of microprocessor control. In the case of microprocessor control, the microprocessor may transmit a signal to a relay which in turn opens and closes an electrical circuit to a valve causing the valve to open and close as required.

As discussed elsewhere herein, some embodiments of the invention are configured for use only with a single concentrate, and in such embodiments there is no requirement to select any particular concentrate by valve or any other means.

One function of the present system (10) is to mix a concentrate (optionally one of a selection of concentrates) with a diluent to provide a diluted composition having a specified concentration of active agent therein. In the embodiment of FIG. 1 a variable flow rate valve (65) is provided to control the rate of egress of concentrate (45a) (45b) or (45c) destined for mixing with the diluent (25). In this embodiment, the function of the flow rate is to limit the maximum rate of concentrate flow through the common concentrate conduit (60).

Generally, whatever force is used to cause the egress of a concentrate from a reservoir, the force is sufficient so as to ensure that the concentrate flow rate does not substantially decrease to below the maximum flow rate specified by the flow rate control valve (65). Expressed another way, the flow of concentrate is always restricted at least to a small extent by the flow rate control valve (65). In this way, the flow rate of concentrate through the common concentrate conduit (60) is essentially set, and does not deviate (positively or negatively) from the flow rate limit set by the flow rate control valve (65). Maintaining a substantially fixed flow rate of concentrate provides for an accurate ratio of concentrate:diluent to be established when the concentrate is mixed with the diluent, at least for embodiments of the system that control the amount of concentrate to be mixed with a diluent by controlling the flow rate of the concentrate.

The flow rate control means is typically configured to finely control flow rate of the concentrate in a continuously variable manner or in a step wise manner. The level of flow rate control may in the region of ±0.1%, ±0.5%, ±1%, ±2%, ±3%, ±4%, ±5%, ±6%, ±7%, ±8%, ±9%, or ±10%.

For continuously variable control means, a needle valve may be used. The advantage of the needle valve arises from the Vernier effect of the ratio between the needle length and its diameter, or the difference in diameter between needle and seat. A long travel axially (the control input) makes for a very small and precise change radially (finely affecting the resultant flow).

In some cases, a flow rate control means is pre calibrated such that a certain setting is known to provide a certain flow rate. Thus, the control means may be set by the worker by manually moving a pointer to a desired indicator on a scale. For example, a needle valve may have rotatable actuator with a pointer and a scale marked in an arc around the actuator such that the actuator may be rotated such that the pointer points to a point on the scale. The scale may read a flow rate, or a ratio of concentrate flow rate to a diluent flow rate, or even concentration of active in the diluted composition where the system has been accordingly calibrated in accordance with the concentration of active in the concentrate. In more complex the needle valve is motor driven and set according the amount of rotation by the motor.

Given the benefit of the present specification, the skilled person is enabled to use any means known to vary the flow rate of a liquid flowing in the system of the present invention.

Many different types of flow rate controllable valves are known. One type is the orifice type. When used to control flow, the orifice is placed in series with the pump. An orifice can be a drilled hole in a fitting, in which case it is fixed; or it may be a calibrated needle valve, in which case it functions as a variable orifice.

In some embodiments, the flow rate control means is controlled by reference to a downstream flow sensor. In such cases, a feedback mechanism (that may be mechanical, electromechanical, or electronic in nature) allows for an output of a downstream flow sensor to control the flow rate control means. Upon sensing of a higher than desired flow rate, the flow rate control means is down regulated, and is upregulated upon sensing of a lower than desired flow rate control means.

Another type is a flow regulator, consisting of an orifice that senses flow rate as a pressure drop across the orifice; a compensating piston adjusting to variations in inlet and outlet pressures. This compensating ability provides closer control of flow rate under varying pressure conditions. Control accuracy may be 5%, possibly less with specially calibrated valves that operate around a given flow-rate point.

Another type is a bypass flow regulator in which liquid flow in excess of a set flow rate returns to a reservoir through a bypass port. Flow rate is controlled by throttling fluid across a variable orifice regulated by the compensator piston. The bypass flow regulator is more efficient than a standard flow regulator.

In demand-compensated flow control regulators liquid is routed at a controlled flow rate to a primary circuit, and bypass fluid can be used for work functions in secondary circuits without affecting the primary circuit.

Another type of flow regulator is a pressure-compensated, variable flow valve. This type of flow control is equipped with an adjustable variable orifice placed in series with a compensator. The compensator automatically adjusts to varying inlet and load pressures, maintaining an essentially constant flow rate under these operating conditions to accuracy of 3% to 5%, FIG. 5. Pressure-compensated, variable flow-control valves are available with integral reverse-flow check valves (which allow fluid to flow unrestricted in the opposite direction) and integral overload relief valves (which route fluid to a tank when a maximum pressure is exceeded).

Pressure- and temperature-compensated, variable flow valves may be used where the viscosity of a concentrate varies with temperature and output of a flow-control valve may drift with temperature changes. To offset the effects of such temperature variations, temperature compensators adjust the control orifice openings to correct the effects of viscosity changes caused by temperature fluctuations of the fluid. This is typically done in combination with adjustments the control orifice for pressure changes as well.

Another type of flow control means is a priority valves, being essentially a flow-control valve that supplies fluid at a set flow rate to the primary circuit, thus functioning as a pressure-compensated flow-control valve. Flow in excess of that required by the primary circuit bypasses to a secondary circuit at a pressure somewhat below that of the primary circuit. Should inlet or load pressure (or both) vary, the primary circuit has priority over the secondary as far as supplying the required flow rate is concerned.

Flow control in the present system may be achieved by non-valve means in some circumstances. For example, flow dividers is a form of pressure-compensated flow-control valve that receives one input flow and splits it into two output flows. The valve can deliver equal flows in each stream or, if necessary, a predetermined ratio of flows.

The egress of a concentrate from its reservoir may be the result of gravity, pressure within the liquid, some pushing force behind the liquid, some vacuum in front of the liquid, or a pump for example. Thus, in some embodiments the egress is not controlled by a flow rate control valve but instead by altering a pressure or a modulating a pushing force or some means other than a valve.

In some embodiments of the system, variable flow control is not required. In one such embodiment, the system is set of mix a diluent and concentrate at a set ratio, say 9:1. Thus, concentrate must always be supplied as a 10-fold concentrate (i.e. 10-fold greater than the desired final concentration in the diluted composition) such that the output diluted composition always comprises the correct concentration of the active. In such a case, flow control may be provided by simply using conduits of differing bore sizes (larger bores allow for a greater rate of flow).

In the embodiment of FIG. 1, a pressure shut off valve (70) is disposed downstream from the flow rate control valve (65). The pressure shut off valve (70) functions to prevent full suction of a downstream pump (100) is inadvertently applied to the common concentrate conduit (60) in the event that diluent outlet conduit (30) is closed. In the embodiment of FIG. 1, the common concentrate conduit (60) comprises an in line isolation valve (75) and the diluent outlet conduit comprises an in line isolation valve (80). Under some operating conditions the isolation valve (75) may be open and the isolation valve (80) may be closed, and in which case the entire suction force is applied to the output side of the flow rate control valve (65). Excessive load may be placed on the pump (100) in which case the pressure shut off valve acts to interrupt current to the pump (100)

As will be appreciated, at some point within the system the diluent is brought into contact with concentrate. While a discrete mixing vessel may be provided for that purpose, in the embodiment of FIG. 1 the common concentrate conduit is simply joined with the diluent outlet conduit by way of a junction fitting (85). A diluted composition conduit (90) conveys the mixture of diluent (25) and concentrate (45a) (45b) or (45c) away from the junction fitting (85) and toward the system output.

The mixture emerging from the junction fitting may be passed through a mixer, such as the static mixer (95) disposed in the diluted composition conduit (90).

The embodiment of FIG. 1 operates so as to draw both concentrate and diluent from their respective reservoirs by connection to the input side of a pump (100). The suction provided by the input side of the pump (100) acts as the liquid motive force for the system (10). The positioning of the pump (100), being in line with a common conduit (being the diluted composition conduit (90)) joining the common concentrate conduit (60) and the diluent outlet conduit (30). Accordingly, the pump (100) acts to draw both diluent (25) and concentrate (45a) (45b) or (45c) and to mix those liquids within the diluted composition conduit (90) before output (on the downstream side of the pump (100) by the system).

In the embodiment of FIG. 1, two flow meters (120) (125) are provided. Furthermore, a flow meter may also be provided on flow control valve (65). The output of these meters may be visualised by the worker operating the system to check whether liquid flow through any of the conduits (60) (30) or (90) is as expected. Alternatively, the flow meter output may be an electric or electronic signal used as input in an electric or electronic control circuit of the system. Electronic control of the system via processor and associated program instructions are discussed further infra.

In the system drawn in FIG. 1, the diluted composition is output by the pump (100) and into a hose (105) spooled onto a reel (110). The hose (105) has a nozzle (115) fitted to its terminus.

Production of a diluted composition having a specified concentration of an active agent from a concentrate of that agent is readily achievable by a consideration of the dilution ratio required. For example, where a concentrate contains a herbicide at a concentration of 100 mg/ml and the concentration required to treat a given weed species is 10 mg/ml, then a dilution of 1/10 is required. A dilution of 1/10 is provided by mixing the concentrate with diluent at a volume ratio of 1:9. In that case, 1 volume of concentrate must be mixed with 9 volumes of diluent. Thus, where the flow rate of diluent from the reservoir is 90 ml/min, then the flow rate of concentrate must be set at 10 ml/min.

In some circumstances, the flow rate of diluent will be fixed for the system, and the flow rate of the concentrate varied to provide the desired concentration of active in the diluted composition output by the system. In other circumstances the flows rate of both the concentrate and diluent may be variable to achieve the desired flow rate ratio. In other situations the flow rate of the concentrate is fixed, and only the flow rate of diluent is varied. This latter situation is less preferred because of the large possible variations in flow rate of output diluted composition.

In a modification from the embodiment of FIG. 1 or any other embodiment described or claimed herein, the diluted composition is not directly output from the system. Instead, the correct ratios of concentrate and diluent are dispensed into a reservoir of the system where they mix (possibly with the aid of a mechanical stirrer). To explain further in the context of the embodiment of FIG. 1, diluent output by conduit (30) is fed into a reservoir, and concentrate output via conduit (60) is fed into the same reservoir for mixing. The diluted composition may be stored in the reservoir and used in a batch-wise manner, or alternatively continuously output. Where batch-wise applications are used the well-known formula may be used:

C₁V₁=C₂V₂

where:

C₁ is the concentration of active in the concentrate,

C₂ is the concentration of active required in the diluted composition,

V₁ is the volume of concentrate required, and

V₂ is the volume of diluted composition required

It is possible for the present system to be operable entirely manually. For example, any flow rate may be adjusted by a worker such as by setting of a calibrated needle valve according to a scale. In other embodiments the system may be under processor control at least in part. The processor may be on board, or remote. An example of a remote processor is a mobile device processor (such as found on a smart phone, tablet or laptop computer) that is configured to transmit wireless signals to the system. The wireless signals may actuate a servo motor or stepper motor or solenoid which in turn actuate a valve or other flow control means, or a pumping means.

The processor will be typically under program instructions via an operating system (for example, Android™, iOS™, Windows™ or Linux™), and receive input from an electronic user interface and output electronic signals to various system components. The user interface may accept input of parameters such as selection of active agent, concentration of active agent in a concentrate stored in a concentrate reservoir of the system, concentration of active in the output diluted composition, required flow rate of the output diluted composition, and the like. Having input those parameters, the program instructions may direct the processor to perform calculations of flow rates for the concentrate and diluent. Alternative to the performance of any calculations, the system may comprise non-volatile memory having a look-up table stored therein. Once any calculations or look-ups are performed, the processor may then direct the system commence operation by moving concentrate and diluent from their respective reservoirs at required ratios for subsequent mixing and output from the system.

Wireless remote control may be by way of Bluetooth™ or Ant™ protocol, in which case the present system will comprise a Bluetooth™ or Ant™ module in operable communication with a system processor.

Where remote control over longer distances is required, the system may be operable by way of a cellular phone network whereby a smart phone comprises controller application software. The controller application software may send (and optionally receive) data to/from the cellular phone network. The present system in such embodiments comprises a cellular phone module configured to receive (and optionally send) data to/from the cellular phone network, the module in operable communication with a processor of the present system.

Other wireless means of remote control include the use of a hand-held radio transmitter controller operable by the user, and a complimentary radio receiver in operable connection with the present system. The transmitter may utilize unregulated frequencies (such as 27 MHz) to send radio-encoded instructions to the system so as to alter system settings. The radio receiver may directly control system hardware, or alternatively via a system processor.

Remote control may be effected also by wired connection between a hardware controller held by the user at the nozzle end of a hose of the system and a system processor. The controller may alternative directly control a valve and/or a pump of the system. In any event. The wire may conveniently be attached to a hose of the system such that when the user roll out the hose, the wire of the remote control is also rolled out.

Remote control of the present system provides significant operational advantage where the user is dispensing diluted composition at some distance from the major components of the system (such as the diluent reservoir, composition reservoirs, and pumps. For example, the major systems components may be mounted on the tray of a vehicle and the vehicle is left stationary while user walks about treating various areas of noxious weed by the use of an extended hose. If the user were to encounter a weed needing a different herbicide to the other weeds under treatment, the remote control function negates the need for the user to walk back to the vehicle (which may be 50 meters or even 100 meters) to manually change system settings at the vehicle.

In some embodiments, the diluent reservoir comprises means for preventing or inhibiting a destabilising movement of a diluent in the diluent reservoir. In some embodiments of the invention, the diluent reservoir holds hundreds of litres of water. When the reservoir is not completely full, the headspace with the reservoir allows water to shift about and destabilise a platform on which it is disposed. This causes problems especially where the system is mounted on a motor vehicle. When cornering, the motor vehicle may become destabilised or even tip due to bulk shifting of water in the diluent reservoir. To address that problem, the diluent reservoir may comprise an internal network of cells (which may be interconnected cells whereby some movements of liquid between cells is permitted), the cells configured such that in use, movement of liquid between adjacent cells of the network of cells is prevented or retarded such that under conditions of liquid movement within the tank, kinetic energy transferred from the liquid to the tank wall is reduced. Reference is made to the Applicant's published international patent specification WO 2017/197464 A1 providing further teaching on various contrivances disposable within a tank to prevent the bulk movement of liquids contained therein during transport.

Diluted composition output by the system may be directly applied to a target (such as a weed) in which case an appropriate dispensing fitting (such as a spray or jet apparatus) may be used. Alternatively, the diluted composition may be dispensed into another reservoir (such as a backpack spray apparatus) in which case no dispensing fitting would be generally required.

In some embodiments of the invention the concentrates within the concentrate reservoirs are coloured differently (for example with a dye additive) such that it is apparent to the user when a diluted composition output by the system has been changed. Where a length of hose is used, the original diluted composition in the hose must be purged before the newly selected diluted composition arrives at the outlet of the hose. The successful purging is detected visually by the user as a change in colour of the liquid output by the hose. In the absence of such visual confirmation, the user may be forced to guess when the newly selected composition starts to flow.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A system for dispensing a liquid composition, the system comprising:
a first concentrate reservoir,
a diluent reservoir, and
a diluent composition conduit,
wherein the system is configured such that a diluent in the diluent reservoir is contactable with a concentrate of the first concentrate reservoir to form a first diluted composition of a specified concentration.

2. The system of claim 1 comprising a second concentrate reservoir, wherein the system is configured such that a diluent in the diluent reservoir is contactable alternately with (i) a concentrate of the first concentrate reservoir to form a first diluted composition of a specified concentration and (ii) a concentrate of the second concentrate reservoir to form a second diluted composition of specified concentration so as to form a second diluted composition.

3. (canceled)

4. (canceled)

5. The system of claim 2, wherein each of the first and second concentrate reservoirs has (i) a first and second concentrate outlet conduit respectively and (ii) first and second concentrate flow control elements configured to control the flow of concentrate through the first and second concentrate outlet conduits respectively, wherein the system is configured such that concentrate flow through the first and second concentrate outlet conduits is independently controllable.

6. The system of claim 5, wherein the first and second concentrate flow control elements are each a valve configured to adopt either an open or closed state.

7. The system of claim 2 configured such that a concentrate is prevented from passing between: (i) the first and second concentrate reservoirs, and/or the diluent reservoir and the first concentrate reservoir and/or the diluent reservoir and the second concentrate reservoir, or (ii) the first and second concentrate reservoirs.

8. (canceled)

9. The system of claim 5 wherein the first and second concentrate outlet conduits are not in mutual liquid communication upstream of the first and second concentrate flow control elements when the first and second concentrate flow control elements are closed to prevent concentrate flow, but are in mutual liquid communication downstream of the first and second concentrate flow control elements when the first and second concentrate control flow elements are open to allow concentrate flow.

10. The system of claim 5, wherein the diluent reservoir has a diluent outlet conduit that is not in liquid communication with the first and second concentrate outlet conduits upstream of the first and second concentrate flow control elements when the first and second concentrate flow control elements are closed to prevent liquid flow, but is in liquid communication with the first and second concentrate outlet conduits downstream of the first and second concentrate flow control elements.

11. The system of claim 5, wherein the first and second concentrate outlet conduits combine so as to form a common concentrate conduit, such combination occurring downstream of the first and second concentrate flow control elements.

12. The system of claim 10, comprising a liquid flow rate control element configured to vary the flow rate of a liquid flowing through at least one of the first concentrate outlet conduit, the second concentrate outlet conduit, the diluent outlet conduit, and the common concentrate conduit, wherein the liquid flow rate control element functions so as to vary the ratio of a diluent from the diluent reservoir to a concentrate from the first or second concentrate reservoir in the diluted composition outlet.

13. (canceled)

14. (canceled)

15. (canceled)

16. The system of claim 10, configured such that a diluent flowing through the diluent outlet conduit combines with a concentrate flowing through the first or second concentrate outlet conduit so as to form a diluted composition.

17. The system of claim 10, wherein the diluted composition conduit is in liquid communication with
(i) the diluent outlet conduit and
(ii) the first concentrate outlet conduit, the second concentrate outlet conduit outlet, or the diluted composition conduit.

18. The system of claim 17 comprising a conduit junction configured to provide liquid communication between
(i) the diluent outlet conduit and
(ii) the first concentrate outlet conduit, the second concentrate outlet conduit outlet, or the diluted composition conduit.

19. The system of claim 1, wherein the diluted composition conduit comprises an in line liquid mixer.

20. The system of claim 1 comprising a liquid transport element configured to transport a diluted composition through the diluted composition conduit.

21. (canceled)

22. The system of claim 1, wherein the diluted composition conduit comprises an outlet and a pump, and the pump is positioned so as to receive diluted composition and transport the diluted composition toward the outlet of the diluted composition conduit.

23. The system of claim 22 comprising a conduit junction configured to provide liquid communication between
(i) the diluent outlet conduit and
(ii) the first concentrate outlet conduit, the second concentrate outlet conduit outlet, or the diluted composition conduit,
wherein the pump is positioned downstream from the conduit junction.

24. The system of claim 22, wherein the pump is positioned downstream from the concentrate flow rate control elements.

25. The system of claim 1 comprising a liquid dispenser, wherein the diluted composition conduit feeds the liquid dispenser.

26. (canceled)

27. The system of claim 25 comprising an elongate and flexible conduit disposed downstream from the diluted composition conduit and upstream from the liquid dispenser.

28. A mobile platform having the system of claim 1 mounted thereon, therein, or thereabout.

29. (canceled)
